(19) United States
(12) Patent Application Publication
(10) Pub. No.: US 2021/0056647 A1
(43) Pub. Date: Feb. 25, 2021

(54) METHOD FOR MULTI-DIMENSIONAL IDENTIFICATION OF FLEXIBLE LOAD DEMAND RESPONSE EFFECT

(71) Applicant: NORTH CHINA ELECTRIC POWER UNIVERSITY, Beijing (CN)

(72) Inventors: Dunnan LIU, Beijing (CN); Pengfei LI, Beijing (CN); Rui GE, Beijing (CN); Xingkai WANG, Beijing (CN); Zhi CAI, Beijing (CN); Yiding JIN, Beijing (CN); Changyou FENG, Beijing (CN); Zhao ZHAO, Beijing (CN); Nan WANG, Beijing (CN); Da SONG, Beijing (CN); Jiangyan LIU, Beijing (CN); Jinshan HAN, Beijing (CN)

(21) Appl. No.: 16/989,511

(22) Filed: Aug. 10, 2020

(30) Foreign Application Priority Data
Aug. 23, 2019 (CN) 201910785597. 8

(51) Int. Cl. G06Q 50/06; G06F 16/23; G06Q 30/02; G06Q 10/06; G05B 13/02; H02J 13/00

(52) U.S. Cl. CPC G06Q 50/06; G06F 16/2365; G06Q 30/0205; H02J 13/00002; G06Q 10/06313; G06Q 10/06315; G05B 13/028; G06Q 10/06375

(57) ABSTRACT

A method for multi-dimensional identification of flexible load demand response effects, including: step 1. determining a target object, a target area and a demand response project that participate in the multi-dimensional identification of flexible load demand response effects; step 2. acquiring flexible load evaluation data of the target area and the target object; step 3. performing data cleaning; step 4. preprocessing the flexible load evaluation data; step 5. constructing four characteristic extraction indicators, a peak load reduction rate, a peak-to-valley difference ratio, a load factor ratio and a response status, inputting a predicted value and an actual collected value of maximum and minimum daily loads before and after the flexible load demand response that are obtained from the prepossessing, to generate a matrix for clustering; step 6. clustering the matrix for clustering generated in step 5; step 7. guiding a more targeted development of demand response projects.

### TECHNICAL FIELD

The present disclosure relates to the technical field of demand-side power management, and to a method for identification of demand response effects, in particular to a method for multi-dimensional identification of flexible load demand response effects.

### BACKGROUND

Flexible load refers to electricity consumption changing within a specified interval or moving around between different periods, including adjustable or transferable loads with demand flexibility, and electric vehicles, energy storages, distributed power supplies and microgrids with two-way adjustment capability.

Demand response refers to a variety of short-term behaviors of electricity users to actively adjust the way they use electricity in accordance with electricity price changes and incentive policies. Generally, flexible load is regulated and scheduled by demand response projects. Flexible load scheduling, as a supplement to power generation scheduling, can cut peaks and fill valleys, balance intermittent energy fluctuations and provide auxiliary functions, and thus is a regulative measure that facilities power grid scheduling operations. Identifying the effect of flexible load participation in demand response is of great significance for flexible load scheduling, and can guide the development of demand response projects and enable a more targeted development of demand response projects.

However, most of the existing researches and technologies have focused on identifying and analyzing the potential of flexible load in demand response, mainly used to estimate the effect of demand response projects before they are launched. What lacks is a method to analyze the actual effect of flexible load participation in demand response. The analysis of the actual effect of flexible load participating in demand response is particularly important for flexible load scheduling and for understanding development effects of demand response projects. With the gradual advancement of China's demand response projects, the method for analyzing flexible load demand response effects will play an increasingly important role.

### SUMMARY OF PARTICULAR EMBODIMENTS

An object of the present disclosure is to overcome the drawbacks in the prior art, and to provide a method for multi-dimensional identification of flexible load demand response effects.

The present disclosure solves the technical problems by the following technical solutions:

A method for multi-dimensional identification of flexible load demand response effects, including the following steps:

Step 1. determining a target object, a target area and a demand response project that participate in the multi-dimensional identification of flexible load demand response effects;

Step 2. acquiring flexible load evaluation data of the target area and the target object in step 1;

Step 3. performing data cleaning on the flexible load evaluation data acquired in step 2;

Step 4. preprocessing the flexible load evaluation data after the cleaning in step 3, to obtain a predicted value and an actual collected value of maximum and minimum daily loads respectively before and after the flexible load demand response;

Step 5. constructing four characteristic extraction indicators, a peak load reduction rate, a peak-to-valley difference ratio, a load factor ratio and a response status, inputting the predicted value and the actual collected value of maximum and minimum daily loads before and after the flexible load demand response that are obtained from the prepossessing in step 4, to generate a matrix for clustering;

Step 6. clustering the matrix for clustering generated in step 5;

Step 7. analyzing response characteristics corresponding to different classes based on the clustering result obtained in step 6 and the classes of flexible load demand responses obtained from the clustering, to guide a more targeted development of demand response projects.

Specifically, step 1 includes:

(1) determining a target user group and typical users to participate in the evaluation: selecting a corresponding flexible load and determining an evaluation area;

(2) determining a demand response project to participate in the evaluation, which includes time-of-use pricing, critical peak pricing, real-time pricing, ordered electricity consumption, interruptible load and direct load control.

Specifically, step 2 includes:

acquiring 96-point historical daily load data before a demand response is implemented and 96-point flexible load data after the demand response is implemented for different types of flexible loads from an electricity usage collection system.

Specifically, step 3 includes:

identifying and correcting identifiable errors in the data file by performing consistency checks and processing of missing and invalid values on the data.

Specifically, step 4 includes:

(1) predicting a maximum value qₘₐₓ^{k′ and a minimum value q}ₘᵢₙ^{k′ of a would-have-been flexible load during the period of the demand response based on the historical data of the flexible load, which comprises the following steps:}

\textcircled{1} calculating a yearly load growth rate r, according to the formula below:

$$r = \sqrt[( n - 1 )]{( \frac{{Q}_{n} - {Q}_{1}}{{Q}_{1}} )} - 1 \qquad ( 1 )$$

where r is the yearly load growth rate, n is the year, Qₙ is a total load in the nth year, and Q₁ is a total load in the first year;

\textcircled{2} predicting 96-point load data during the implementation of the demand response project based on the historical load growth rate r, according to the formula below:

qₙ₊₁^{k′,s}=qₙ^{k,s}×(1+r) (2)

where n is the year, k is the kth day, s is the sth point in time, qₙ^{k,s} is an actual load at the sth point on the kth day of the nth year, and qₙ₊₁^{k′,s} is a predicted load at the sth point on the kth day of the (n+1)th year;

\textcircled{3} identifying maximum and minimum values qₘₐₓ^{k′}={qₘₐₓ^{1′}, qₘₐₓ^{2′}, qₘₐₓ^{3′} . . . }, qₘᵢₙ^{k′}={qₘᵢₙ^{1′}, qₘᵢₙ^{2′}, qₘᵢₙ^{3′}. . . }, qₐᵥₑ^{k′}={qₐᵥₑ^{1′}, qₐᵥₑ^{2′}, qₐᵥₑ^{3′}, . . . } from the predicted 96-point load on the kth day of the period of the demand response,

where k denotes the kth day, qₘₐₓ^{k′} denotes a maximum value of the predicted 96-point load on the kth day, and qₘᵢₙ^{k′} denotes a minimum value of the predicted 96-point load on the kth day;

(2) identifying and acquiring maximum and minimum values, qₘₐₓ^{k}={qₘₐₓ¹, qₘₐₓ², qₘₐₓ³ . . . }, qₘᵢₙ^{k}={qₘᵢₙ¹, qₘᵢₙ², qₘᵢₙ³ . . . }, an average value qₐᵥₑ^{k}={qₐᵥₑ¹, qₐᵥₑ², qₐᵥₑ³ . . . } of the load in every k days based on the collected 96-point load data during the actual demand response,

where k denotes the kth day, qₘₐₓ^{k} denotes a maximum value of the 96-point load on the kth day that is actually collected, and qₘᵢₙ^{k} denotes a minimum value of the 96-point load on the kth day that is actually collected.

Specifically, step 5 includes:

(1) extracting four flexible load characteristic indicators, a peak load reduction rate, a peak-to-valley difference ratio, a load factor ratio and a response status:

\textcircled{1} Peak load reduction rate:

PR^{k}=(qₘₐₓ^{k′}−qₘₐₓ^{k})/qₘₐₓ^{k′}×100% (3)

where PR^{k} is a peak load reduction rate on the kth day, and qₘₐₓ^{k′} and qₘₐₓ^{k} are peak loads before and after the flexible load response on the kth day respectively;

\textcircled{2} Peak-to-valley difference ratio:

PtV^{k}=(qₘₐₓ^{k′}−qₘᵢₙ^{k′})/(qₘₐₓ^{k}−qₘᵢₙ^{k})×100% (4)

where PtV^{k} is a peak-to-valley difference ratio on the kth day, and qₘₐₓ^{k′} and qₘₐₓ^{k} are peak loads before and after the flexible load response on the kth day respectively;

\textcircled{3} Load factor ratio:

$${LF}^{k} = \frac{{q}_{ave}^{{k}^{′}}}{{q}_{max}^{{k}^{′}}} \times \frac{{q}_{max}^{k}}{{q}_{ave}^{k}} \times 100 \% \qquad ( 5 )$$

where LF^{k} is a load factor rate on the kth day, qₘₐₓ^{k} is peak load before and after the flexible load response on the kth day, and qₐᵥₑ^{k} is an average value of the flexible load on the kth day;

\textcircled{4} Response status:

$${RS}^{k} = \{ \begin{matrix}1 , {PR}^{k} > α \\ 0 , {PR}^{k} \leq α\end{matrix} \qquad ( 6 )$$

where RS^{k} is a response status on the kth day, PR^{k} is the peak load reduction rate on the kth day, and α is a predetermined threshold for the peak load reduction rate; α is used to determine whether or not to respond: 1 indicates response while 0 indicates non-response;

(2) generating a matrix for clustering from the four flexible load characteristic indicators according to the four flexible load characteristic indicators, peak load reduction rate, peak-to-valley difference ratio, load factor ratio and response status, and

(2) of step 5 specifically comprising:

\textcircled{1} taking four characteristic indicators calculated from a user daily as one sample, so that the user i has a matrix for clustering, Y_{L×4}, that represents a load curve characteristic indicator;

\textcircled{2} with Y_{L×4} being an input, clustering by using Euclidean distance as a similarity criterion,

where L is the duration of the demand response, “4” denotes the number of indicators, and Y_{L×4} is the matrix for clustering.

Specifically, step 6 includes:

(1) repeatedly selecting a cluster center to perform a clustering with the number of clusters being k:

\textcircled{1} determining the number of clusters k to range from kₘᵢₙ=2 to kₘₐₓ=int(\sqrt{x}) where s denotes the number of samples;

\textcircled{2} calculating the distance between each sample and an initial cluster center, and classifying the samples into clusters that minimize the distance;

\textcircled{3} recalculating each cluster center, recalculating the distance, the classification and the cluster center until the number of iterations is reached or the distances within the clusters can no longer be reduced, thereby completing the clustering with the number of clusters being k;

(2) assessing and optimizing the clustering result in (1) of step 6 by using a Silhouette index for calculating the effectiveness of clustering, and determining final number of clusters, clustering result and cluster center:

\textcircled{1} with a (x) being an average distance between a sample x in cluster Cⱼ and all the other samples in the cluster to represent the degree of tightness within the cluster, with d (x, Cᵢ) being an average distance between the sample x and all samples in another cluster Cᵢ, with b (x) being a minimum average distance between the sample x and all samples outside the same cluster as x, to represent the degree of dispersion between clusters, b (x)=min{d(x, Ci)}, i=1, 2, . . . , k, i≠j;

calculating a Silhouette index for each sample x according to equation (7):

$$S ( x ) = \frac{b ( x ) - a ( x )}{min \{ a ( x ) , b ( x ) \}} \qquad ( 7 )$$

where b (x) is the minimum average distance between the sample x and all samples outside the same cluster as x, and a (x) is the average distance between the sample x in cluster Cⱼ and all the other samples in the cluster;

\textcircled{2} obtaining a clustering result and a cluster center from the four flexible load four characteristic indicators, after the optimization of the Silhouette index.

Specifically, step 7 includes:

(1) analyzing response capacity, response speed, response period of each class of flexible load and demand response effects of different demand response projects according to the classification result of different flexible loads from step 6:

\textcircled{1} the magnitude of the peak load reduction rate indicates peak-cutting capability in electricity consumption peak hours;

\textcircled{2} the magnitude of the peak-to-valley difference ratio and the magnitude of the load ratio indicate peak cutting and valley filling capabilities of a user;

\textcircled{3} The transition speed of the response status from 0 to 1 indicates response speed of a user demand response project;

(2) developing demand response projects in a more targeted manner based on the analysis of the user demand response effects in (1) of step 7:

\textcircled{1} If a demand response project requires cutting a peak power load, developing the demand response project mainly for users with a large peak load reduction rate;

\textcircled{2} If a demand response project requires smoothing an electricity usage curve and alleviating peak scheduling of a power grid, developing the demand response project mainly for users with a stable load ratio and a large peak-to-valley difference ratio;

\textcircled{3} If a demand response project requires quick response, developing the demand response project mainly for users with a fast response speed in the response status;

\textcircled{4} If a demand response project requires continuous response, developing the demand response project mainly for users with a long response period in the response status.

The present disclosure has the following advantages and positive effects:

Upon preprocessing flexible load data collected by an electricity usage collecting device, based on four extracted characteristic indicators, a peak load reduction rate, a peak-to-valley difference ratio, a load factor ratio and a response status, the present disclosure extracts flexible load demand response characteristics relatively comprehensively from the aspects of response capacity, response speed and response period, and compares the actual load status with a predicted load status, to scientifically reflect the actual effect of flexible load demand response. Then, the flexible load demand response characteristics are appropriately classified and identified, and demand response projects are developed in a more targeted manner in accordance with the different classes of response characteristics, to achieve such purposes as: when peak cutting, valley filling, rapid demand response or continuous demand response is needed, target users can be discovered so that a more effective flexible load scheduling and demand response project development can be realized.

### BRIEF DESCRIPTION OF THE DRAWINGS

FIG. 1 is a flowchart of a method for multi-dimensional identification of flexible load demand response effects based on collected electricity usage data according to the present disclosure;

FIG. 2 is a schematic diagram of an indicator for multi-dimensional identification of flexible load demand response effects according to the present disclosure.

### DETAILED DESCRIPTION OF PARTICULAR EMBODIMENTS

The embodiments of the present disclosure will be described in detail below with reference to the accompanying drawings.

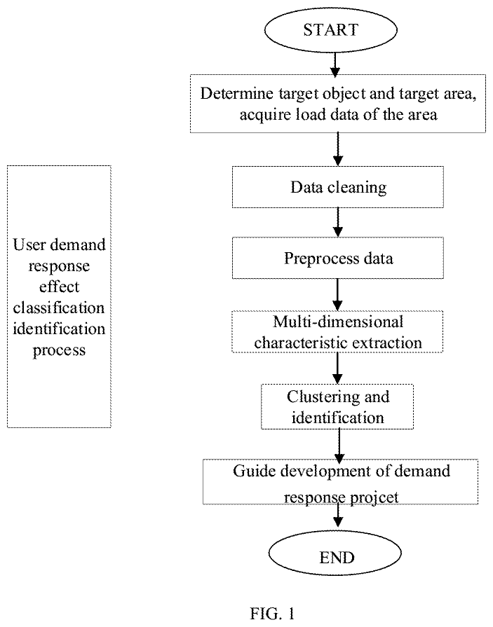

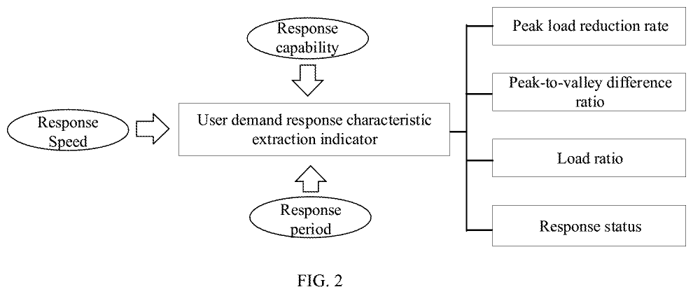

As shown in FIG. 1 and FIG. 2, a method for multi-dimensional identification of flexible load demand response effects includes the following steps:

Step 1. determining a target object, a target area and a demand response project that participate in the multi-dimensional identification of flexible load demand response effects.

Specifically, step 1 includes:

(1) determining a target user group and typical users to participate in the evaluation: selecting a corresponding flexible load and determining an evaluation area;

(2) determining a demand response project to participate in the evaluation, which includes time-of-use pricing, critical peak pricing, real-time pricing, ordered electricity consumption, interruptible load and direct load control.

Step 2. acquiring flexible load evaluation data of the target area and the target object in step 1.

Specifically, step 2 includes:

acquiring 96-point historical daily load data before a demand response is implemented and 96-point flexible load data after the demand response is implemented for different types of flexible loads from an electricity usage collection system.

Step 3. performing data cleaning on the flexible load evaluation data acquired in step 2.

Specifically, step 3 includes:

identifying and correcting identifiable errors in the data file by performing consistency checks and processing of missing and invalid values on the data.

Step 4. preprocessing the flexible load evaluation data after the cleaning in step 3, to obtain a predicted value and an actual collected value of maximum and minimum daily loads respectively before and after the flexible load demand response;

predicting normal daily load data corresponding to the period of the demand response based on historical daily load data, and extracting the maximum and minimum daily loads before and after the flexible load demand response according to actual data from the implemented demand response project.

Specifically, step 4 includes:

(1) predicting a maximum value qₘₐₓ^{k′} and a minimum value qₘᵢₙ^{k′} of a would-have-been flexible load during the period of the demand response based on the historical data of the flexible load, which includes the following steps:

\textcircled{1} calculating a yearly load growth rate r, according to the formula below:

$$r = \sqrt[( n - 1 )]{( \frac{{Q}_{n} - {Q}_{1}}{{Q}_{1}} )} - 1 \qquad ( 1 )$$

where r is the yearly load growth rate, n is the year, Qₙ is a total load in the nth year, and Q₁ is a total load in the first year;

\textcircled{2} predicting 96-point load data during the implementation of the demand response project based on the historical load growth rate r, according to the formula below:

qₙ₊₁^{k′,s}=qₙ^{k,s}×(1+r) (2)

where n is the year, k is the kth day, s is the sth point in time, qₙ^{k,s} is an actual load at the sth point on the kth day of the nth year, and qₙ₊₁^{k′,s} is a predicted load at the sth point on the kth day of the (n+1)th year;

\textcircled{3} identifying maximum and minimum values qₘₐₓ^{k′}={qₘₐₓ^{1′}, qₘₐₓ^{2′}, qₘₐₓ^{3′}. . . }, qₘᵢₙ^{k′}={qₘᵢₙ^{1′}, qₘᵢₙ^{2′}, qₘᵢₙ^{3′}. . . }, ={qₐᵥₑ^{1′}, qₐᵥₑ^{2′}, qₐᵥₑ^{3′} . . . } from the predicted 96-point load on the kth day of the period of the demand response,

where k denotes the kth day, qₘₐₓ^{k′} denotes a maximum value of the predicted 96-point load on the kth day, and qₘᵢₙ^{k′} denotes a minimum value of the predicted 96-point load on the kth day.

(2) identifying and acquiring maximum and minimum values, qₘₐₓ^{k}={qₘₐₓ¹, qₘₐₓ², qₘₐₓ³ . . . }, qₘᵢₙ^{k}={qₘᵢₙ¹, qₘᵢₙ², qₘᵢₙ³ . . . }, an average value qₐᵥₑ^{k}={qₐᵥₑ¹, qₐᵥₑ², qₐᵥₑ³ . . . } of the load in every k days based on the collected 96-point load data during the actual demand response,

where k denotes the kth day, qₘₐₓ^{k} denotes a maximum value of the 96-point load on the kth day that is actually collected, and qₘᵢₙ^{k} denotes a minimum value of the 96-point load on the kth day that is actually collected.

Step 5. constructing four characteristic extraction indicators, a peak load reduction rate, a peak-to-valley difference ratio, a load factor ratio and a response status, inputting the predicted value and the actual collected value of maximum and minimum daily loads before and after the flexible load demand response that are obtained from the prepossessing in step 4, to generate a matrix for clustering;

generating a matrix for clustering according to predetermined characteristic extraction indicators, a peak load reduction rate, a peak-to-valley difference ratio, a load factor ratio and a response status, and by inputting the prepossessed data.

Specifically, step 5 includes:

(1) extracting four flexible load characteristic indicators, a peak load reduction rate, a peak-to-valley difference ratio, a load factor ratio and a response status:

\textcircled{1} Peak load reduction rate:

PR^{k}=(qₘₐₓ^{k′}−qₘₐₓ^{k})/qₘₐₓ^{k′}×100% (3)

where PR^{k} is a peak load reduction rate on the kth day, and qₘₐₓ^{k′} and qₘₐₓ^{k} are peak loads before and after the flexible load response on the kth day respectively;

\textcircled{2} Peak-to-valley difference ratio:

PtV^{k}=(qₘₐₓ^{k′}−qₘᵢₙ^{k′})/(qₘₐₓ^{k}−qₘᵢₙ^{k})×100% (4)

where PtV^{k} is a peak-to-valley difference ratio on the kth day, and qₘₐₓ^{k′} and qₘₐₓ^{k} are peak loads before and after the flexible load response on the kth day respectively;

\textcircled{3} Load factor ratio:

$${LF}^{k} = \frac{{q}_{ave}^{{k}^{′}}}{{q}_{max}^{{k}^{′}}} \times \frac{{q}_{max}^{k}}{{q}_{ave}^{k}} \times 100 \% \qquad ( 5 )$$

where LF^{k} is a load factor rate on the kth day, qₘₐₓ^{k} is peak load before and after the flexible load response on the kth day, and qₐᵥₑ^{k} is an average value of the flexible load on the kth day;

\textcircled{4} Response status:

$${RS}^{k} = \{ \begin{matrix}1 , {PR}^{k} > α \\ 0 , {PR}^{k} \leq α\end{matrix} \qquad ( 6 )$$

where RS^{k} is a response status on the kth day, PR^{k} is the peak load reduction rate on the kth day, and α is a predetermined threshold for the peak load reduction rate; α is used to determine whether or not to respond: 1 indicates response while 0 indicates non-response.

(2) generating a matrix for clustering from the four flexible load characteristic indicators according to the four flexible load characteristic indicators, peak load reduction rate, peak-to-valley difference ratio, load factor ratio and response status.

Specifically, (2) of step 5 includes:

\textcircled{1} taking four characteristic indicators calculated from a user daily as one sample, so that the user i has a matrix for clustering, Y_{L×4}, that represents a load curve characteristic indicator;

\textcircled{2} with Y_{L×4} being an input, clustering by using Euclidean distance as a similarity criterion,

where L is the duration of the demand response, “4” denotes the number of indicators, and Y_{L×4} is the matrix for clustering.

Step 6. clustering by k-means clustering, based on the matrix for clustering generated in step 5;

k-means clustering the matrix for clustering, continuously modifying the number of clusters, and assessing a clustering result by using a Silhouette index.

(1) repeatedly selecting a cluster center to perform a clustering with the number of clusters being k;

\textcircled{1} determining the number of clusters k to range from kₘᵢₙ=2 to kₘₐₓ=int(\sqrt{x}) where s denotes the number of samples;

\textcircled{2} calculating the distance between each sample and an initial cluster center, and classifying the samples into clusters that minimize the distance;

\textcircled{3} recalculating each cluster center, recalculating the distance, the classification and the cluster center until the number of iterations is reached or the distances within the clusters can no longer be reduced, thereby completing the clustering with the number of clusters being k.

(2) assessing and optimizing the clustering result in (1) of step 6 by using a Silhouette index for calculating the effectiveness of clustering, and determining final number of clusters, clustering result and cluster center;

\textcircled{1} with a (x) being an average distance between a sample x in cluster Cⱼ and all the other samples in the cluster to represent the degree of tightness within the cluster, with d (x, Cᵢ) being an average distance between the sample x and all samples in another cluster Cᵢ, with b (x) being a minimum average distance between the sample x and all samples outside the same cluster as x, to represent the degree of dispersion between clusters, b (x)=min{d(x, Ci)}, i=1, 2, . . . , k, i≠j;

calculating a Silhouette index for each sample x according to equation (7):

$$S ( x ) = \frac{b ( x ) - a ( x )}{min \{ a ( x ) , b ( x ) \}} \qquad ( 7 )$$

where b (x) is the minimum average distance between the sample x and all samples outside the same cluster as x, and a (x) is the average distance between the sample x in cluster Cⱼ and all the other samples in the cluster;

The Silhouette index S (x) of the sample x varies within the range of [−1,1]; the smaller a (x) is, the larger b (x) is, the closer S (x) is to 1, and the better the within-cluster tightness and between-cluster dispersion of cluster j to which i belongs are; when a (x)>b (x), S (x)<0, and the distance between the sample x and samples outside the same cluster as x is smaller than the distance between the sample x and the samples in the cluster, which indicates the clustering fails; the larger the Silhouette index is, the better the clustering quality is; the maximum Silhouette index corresponds to the optimal number of clusters.

\textcircled{2} obtaining a clustering result and a cluster center from the four flexible load four characteristic indicators, after the optimization of the Silhouette index.

Step 7. analyzing response characteristics corresponding to different classes based on the clustering result obtained in step 6 and the classes of flexible load demand responses obtained from the clustering, to guide a more targeted development of demand response projects.

Specifically, step 7 includes:

(1) analyzing response capacity, response speed, response period of each class of flexible load and demand response effects of different demand response projects according to the classification result of different flexible loads from step 6.

\textcircled{1} the magnitude of the peak load reduction rate indicates peak-cutting capability in electricity consumption peak hours, i.e., the capability of reduction of the demand response. The greater the peak load reduction rate is, the greater the response capacity;

\textcircled{2} the magnitude of the peak-to-valley difference ratio and the magnitude of the load ratio indicate peak cutting and valley filling capabilities of a user. In the case where the load ratio does not vary largely, the greater the peak-to-valley difference ratio is, the stronger the peak cutting and valley filling capabilities of the user is.

\textcircled{3} The transition speed of the response status from 0 to 1 indicates response speed of a user demand response project, i.e., the length of time from when a user does not respond to when the user responds. The more the number of 1s in the response statuses, the longer the time the user responds, and the longer the response period is.

(2) developing demand response projects in a more targeted manner based on the analysis of the user demand response effects in (1) of step 7.

\textcircled{1} If a demand response project requires cutting a peak power load, developing the demand response project mainly for users with a large peak load reduction rate;

\textcircled{2} If a demand response project requires smoothing an electricity usage curve and alleviating peak scheduling of a power grid, developing the demand response project mainly for users with a stable load ratio and a large peak-to-valley difference ratio;

\textcircled{3} If a demand response project requires quick response, developing the demand response project mainly for users with a fast response speed in the response status;

\textcircled{4} If a demand response project requires continuous response, developing the demand response project mainly for users with a long response period in the response status.

The demand response project can also be designed and implemented for targeted users by synthetically considering various characteristics and needs.

From the calculation process above, it can be seen that this method synthetically considers such characteristics as response capacity, response speed and response period, relatively comprehensively measures the effects of flexible load demand response, compares the actual load status with a predicted load status, and can scientifically reflect the effect of flexible load demand response. The whole calculation process is clear-thinking and has a good applicability, making it suitable for wide application.

It should be noted that the embodiments described herein are for illustrative purposes only and shall not be construed as limiting the scope of the present invention. Therefore, those embodiments made by the skilled in the art based on the embodiments described herein shall fall within the scope of the present invention.

What is claimed is:

1. A method for multi-dimensional identification of flexible load demand response effects, comprising:
Step 1. determining a target object, a target area and a demand response project that participate in the multi-dimensional identification of flexible load demand response effects;
Step 2. acquiring flexible load evaluation data of the target area and the target object in step 1;
Step 3. performing data cleaning on the flexible load evaluation data acquired in step 2;
Step 4. preprocessing the flexible load evaluation data after the cleaning in step 3, to obtain a predicted value and an actual collected value of maximum and minimum daily loads respectively before and after the flexible load demand response;
Step 5. constructing four characteristic extraction indicators, a peak load reduction rate, a peak-to-valley difference ratio, a load factor ratio and a response status, inputting the predicted value and the actual collected value of maximum and minimum daily loads before and after the flexible load demand response that are obtained from the prepossessing in step 4, to generate a matrix for clustering;
Step 6. clustering the matrix for clustering generated in step 5;
Step 7. analyzing response characteristics corresponding to different classes based on the clustering result obtained in step 6 and the classes of flexible load demand responses obtained from the clustering, to guide a more targeted development of demand response projects.

2. The method for multi-dimensional identification of flexible load demand response effects according to claim 1, wherein step 1 comprises:
(1) determining a target user group and typical users to participate in the evaluation: selecting a corresponding flexible load and determining an evaluation area;
(2) determining a demand response project to participate in the evaluation, which includes time-of-use pricing, critical peak pricing, real-time pricing, ordered electricity consumption, interruptible load and direct load control.

3. The method for multi-dimensional identification of flexible load demand response effects according to claim 1, wherein step 2 comprises:
acquiring 96-point historical daily load data before a demand response is implemented and 96-point flexible load data after the demand response is implemented for different types of flexible loads from an electricity usage collection system.

4. The method for multi-dimensional identification of flexible load demand response effects according to claim 1, wherein step 3 comprises:
identifying and correcting identifiable errors in the data file by performing consistency checks and processing of missing and invalid values on the data.

5. The method for multi-dimensional identification of flexible load demand response effects according to claim 1, wherein step 4 comprises:
(1) predicting a maximum value qₘₐₓ^{k′} and a minimum value qₘᵢₙ^{k′} of a would-have-been flexible load during the period of the demand response based on the historical data of the flexible load, which comprises the following steps:
\textcircled{1} calculating a yearly load growth rate r, according to the formula below:
$$r = \sqrt[( n - 1 )]{( \frac{{Q}_{n} - {Q}_{1}}{{Q}_{1}} )} - 1 \qquad ( 1 )$$
where r is the yearly load growth rate, n is the year, Qₙ is a total load in the nth year, and Q₁ is a total load in the first year;
\textcircled{2} predicting 96-point load data during the implementation of the demand response project based on the historical load growth rate r, according to the formula below:
qₙ₊₁^{k′,s}=qₙ^{k,s}×(1+r) (2)
where n is the year, k is the kth day, s is the sth point in time, qₙ^{k,s} is an actual load at the sth point on the kth day of the nth year, and qₙ₊₁^{k′,s} is a predicted load at the sth point on the kth day of the (n+1)th year;
\textcircled{3} identifying maximum and minimum values qₘₐₓ^{k′}={qₘₐₓ^{1′}, qₘₐₓ^{2′}, qₘₐₓ^{3′} . . . }, qₘᵢₙ^{k′}={qₘᵢₙ^{1′}, qₘᵢₙ^{2′}, qₘᵢₙ^{3′}. . . }, qₐᵥₑ^{k′}={qₐᵥₑ^{1′}, qₐᵥₑ^{2′}, qₐᵥₑ^{3′} . . . } from the predicted 96-point load on the kth day of the period of the demand response,
where k denotes the kth day, qₘₐₓ^{k′} denotes a maximum value of the predicted 96-point load on the kth day, and qₘₐₓ^{k′} d denotes a minimum value of the predicted 96-point load on the kth day;
(2) identifying and acquiring maximum and minimum values, qₘₐₓ^{k}={qₘₐₓ¹, qₘₐₓ², qₘₐₓ³ . . . }, qₘᵢₙ^{k}={qₘᵢₙ¹, qₘᵢₙ², qₘᵢₙ³ . . . }, an average value qₐᵥₑ^{k}={qₐᵥₑ¹, qₐᵥₑ², qₐᵥₑ³ . . . } of the load in every k days based on the collected 96-point load data during the actual demand response,
where k denotes the kth day, qₘₐₓ^{k} denotes a maximum value of the 96-point load on the kth day that is actually collected, and qₘᵢₙ^{k} denotes a minimum value of the 96-point load on the kth day that is actually collected.

6. The method for multi-dimensional identification of flexible load demand response effects according to claim 1, wherein step 5 comprises:
(1) extracting four flexible load characteristic indicators, a peak load reduction rate, a peak-to-valley difference ratio, a load factor ratio and a response status:
\textcircled{1} Peak load reduction rate:
PR^{k}=(qₘₐₓ^{k′}−qₘₐₓ^{k})/qₘₐₓ^{k′}×100% (3)
where PR^{k} is a peak load reduction rate on the kth day, and qₘₐₓ^{k′} and qₘₐₓ^{k} are peak loads before and after the flexible load response on the kth day respectively;
\textcircled{2} Peak-to-valley difference ratio:
PtV^{k}=(qₘₐₓ^{k′}−qₘᵢₙ^{k′})/(qₘₐₓ^{k}−qₘᵢₙ^{k})×100% (4)
where PtV^{k} is a peak-to-valley difference ratio on the kth day, and qₘₐₓ^{k′} and qₘₐₓ^{k} are peak loads before and after the flexible load response on the kth day respectively;
\textcircled{3} Load factor ratio:
$${LF}^{k} = \frac{{q}_{ave}^{{k}^{′}}}{{q}_{max}^{{k}^{′}}} \times \frac{{q}_{max}^{k}}{{q}_{ave}^{k}} \times 100 \% \qquad ( 5 )$$
where LF^{k} is a load factor rate on the kth day, qₘₐₓ^{k} is peak load before and after the flexible load response on the kth day, and qₐᵥₑ^{k} is an average value of the flexible load on the kth day;
\textcircled{4} Response status:
$${RS}^{k} = \{ \begin{matrix}1 , {PR}^{k} > α \\ 0 , {PR}^{k} \leq α\end{matrix} \qquad ( 6 )$$
where RS^{k} is a response status on the kth day, PR^{k} is the peak load reduction rate on the kth day, and α is a predetermined threshold for the peak load reduction rate; α is used to determine whether or not to respond: 1 indicates response while 0 indicates non-response;
(2) generating a matrix for clustering from the four flexible load characteristic indicators according to the four flexible load characteristic indicators, peak load reduction rate, peak-to-valley difference ratio, load factor ratio and response status, and
(2) of step 5 specifically comprising:
\textcircled{1} taking four characteristic indicators calculated from a user daily as one sample, so that the user i has a matrix for clustering, Y_{L×4}, that represents a load curve characteristic indicator;
\textcircled{2} with Y_{L×4} being an input, clustering by using Euclidean distance as a similarity criterion,
where L is the duration of the demand response, “4” denotes the number of indicators, and Y_{L×4} is the matrix for clustering.

7. The method for multi-dimensional identification of flexible load demand response effects according to claim 1, wherein step 6 comprises:
(1) repeatedly selecting a cluster center to perform a clustering with the number of clusters being k:
\textcircled{1} determining the number of clusters k to range from kₘᵢₙ=2 to kₘₐₓ=int(\sqrt{x}), where s denotes the number of samples;
\textcircled{2} calculating the distance between each sample and an initial cluster center, and classifying the samples into clusters that minimize the distance;
\textcircled{3} recalculating each cluster center, recalculating the distance, the classification and the cluster center until the number of iterations is reached or the distances within the clusters can no longer be reduced, thereby completing the clustering with the number of clusters being k;
(2) assessing and optimizing the clustering result in (1) of step 6 by using a Silhouette index for calculating the effectiveness of clustering, and determining final number of clusters, clustering result and cluster center:
\textcircled{1} with a (x) being an average distance between a sample x in cluster Cⱼ and all the other samples in the cluster to represent the degree of tightness within the cluster, with d (x, Cᵢ) being an average distance between the sample x and all samples in another cluster Cᵢ, with b (x) being a minimum average distance between the sample x and all samples outside the same cluster as x, to represent the degree of dispersion between clusters, b (x)=min {d (x, Ci)}, i=1, 2, . . . , k, i≠j;
calculating a Silhouette index for each sample x according to equation (7):
$$S ( x ) = \frac{b ( x ) - a ( x )}{min \{ a ( x ) , b ( x ) \}} \qquad ( 7 )$$
where b (x) is the minimum average distance between the sample x and all samples outside the same cluster as x, and a (x) is the average distance between the sample x in cluster Cⱼ and all the other samples in the cluster;
\textcircled{2} obtaining a clustering result and a cluster center from the four flexible load four characteristic indicators, after the optimization of the Silhouette index.

8. The method for multi-dimensional identification of flexible load demand response effects according to claim 1, wherein step 7 comprises:
(1) analyzing response capacity, response speed, response period of each class of flexible load and demand response effects of different demand response projects according to the classification result of different flexible loads from step 6:
\textcircled{1} the magnitude of the peak load reduction rate indicates peak-cutting capability in electricity consumption peak hours;
\textcircled{2} the magnitude of the peak-to-valley difference ratio and the magnitude of the load ratio indicate peak cutting and valley filling capabilities of a user;
\textcircled{3} The transition speed of the response status from 0 to 1 indicates response speed of a user demand response project;
(2) developing demand response projects in a more targeted manner based on the analysis of the user demand response effects in (1) of step 7:
\textcircled{1} If a demand response project requires cutting a peak power load, developing the demand response project mainly for users with a large peak load reduction rate;
\textcircled{2} If a demand response project requires smoothing an electricity usage curve and alleviating peak scheduling of a power grid, developing the demand response project mainly for users with a stable load ratio and a large peak-to-valley difference ratio;
\textcircled{3} If a demand response project requires quick response, developing the demand response project mainly for users with a fast response speed in the response status;
\textcircled{4} If a demand response project requires continuous response, developing the demand response project mainly for users with a long response period in the response status.
